(19) United States
(12) Patent Application Publication
(10) Pub. No.: US 2008/0250464 A1
(43) Pub. Date: Oct. 9, 2008

(54) System for Providing Multimedia Content to Customers and Method Thereof

(75) Inventors: Jeffrey A. Masucci, Windham, NH (US); Alan P. Calamari, Windham, NH (US); Agnes Masucci, Windham, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: PIXADS, LLC, Windham, NH (US)

(21) Appl. No.: 12/018,871

(22) Filed: Jan. 24, 2008

Related U.S. Application Data
(63) Continuation of application No. 12/018,662, filed on Jan. 23, 2008.
Application No. 12/018,662 is a continuation of application No. 12/018,617, filed on Jan. 23, 2008.
Application No. 12/018,617 is a continuation of application No. 12/018,565, filed on Jan. 23, 2008.
Application No. 12/018,565 is a continuation of application No. 11/972,973, filed on Jan. 11, 2008.
Application No. 11/972,973 is a continuation of application No. PCT/US08/50594, filed on Jan. 9, 2008.
(60) Provisional application No. 60/884,669, filed on Jan. 12, 2007.

(51) Int. Cl. H04N 7/18

(52) U.S. Cl. 725/82; 725/85

(57) ABSTRACT

Disclosed are a system and a method for providing multimedia content to customers at a vendor location. A control server and a plurality of patron devices are provided at the vendor location. The control server receives the multimedia content from at least one multimedia content source. Each patron device of the plurality of patron devices communicates with the control server over a communication network for receiving the multimedia content from the control server. The each patron device displays the multimedia content received from the control server for providing the multimedia content to a customer. The each patron device is configured to receive customer input and communicate multimedia content information to the control server based on the customer input. The control server may provide the multimedia content to the each patron device based on the multimedia content information received from the each patron device.

### CROSS-REFERENCE TO RELATED APPLICATIONS

The present application is a continuation of U.S. patent application Ser. No. 12/018,662, filed Jan. 23, 2008, which is a continuation of U.S. patent application Ser. No. 12/018,617, filed Jan. 23, 2008, which is a continuation of U.S. patent application Ser. No. 12/018,565, filed Jan. 23, 2008, which is a continuation of U.S. patent application Ser. No. 11/972,973, filed Jan. 11, 2008, which is a continuation of International Patent Application Ser. No. PCT/US08/50594, designating the United States and filed Jan. 9, 2008, and which claims the benefit of the filing date of U.S. Provisional Application Ser. No. 60/884,669, filed Jan. 12, 2007, the teachings of which applications are hereby incorporated herein by reference.

### FIELD OF THE DISCLOSURE

The present disclosure generally relates to content delivery mechanisms, and, more particularly, to a system and method for providing multimedia content to customers at a vendor location.

### BACKGROUND

Networks such as the Internet are widely used for providing and transmitting content from one location to another. Portal servers storing content such as text, graphics and animation serve as a source for content and transmit the content over a variety of networks to remote destination servers. The remote destination server uses a last-mile network such as a wireless Local Area Network (WLAN) to deliver the content to consumers desiring access to the content.

Although the concept of providing content is fairly developed, mechanisms for providing targeted content to consumers are still developing. Providing content targeted at consumers may be particularly useful for business enterprises for promoting products and services of the business enterprises. For example, providing targeted content such as advertisements directed towards promoting products and services may help boost sales of the product and services of the business enterprises.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates an environment in which various embodiments of the present disclosure may be practiced;

FIG. 2 is a block diagram of a patron device, in accordance with an embodiment of the present disclosure;

FIG. 3A illustrates an exemplary opening screen displayed on a display screen of the patron device of FIG. 2, in accordance with an embodiment of the present disclosure

FIG. 3B illustrates an exemplary display screen depicting multimedia content corresponding to an application selected by a customer using an icon, in accordance with an embodiment of the present disclosure;

FIGS. 4A and 4B illustrate a patron device configured with a card reader for integrating with a Point-of-Sale (POS) system at a vendor location, and a display screen of the patron device configured for receiving customer email information respectively, in accordance with an exemplary embodiment of the present disclosure;

FIGS. 5A, 5B, 5C and 5D illustrate assignment of patron devices of a plurality of patron devices, in accordance with an embodiment of the present disclosure;

FIG. 6 illustrates an exemplary promotion of a special event at a vendor location using a master patron device, in accordance with an embodiment of the present disclosure;

FIGS. 7A, 7B and 7C refer to charging of patron devices, in accordance with an embodiment of the present disclosure;

FIG. 8 illustrates variation in signal levels received by a plurality of patron devices in communication with a wireless access point with increasing distance from a wireless access point, in accordance with an embodiment of the present disclosure;

FIG. 9 illustrates an survey application display screen displayed on the display screen of a patron device in accordance with an exemplary embodiment of the present disclosure;

FIG. 10 illustrates an exemplary scenario for providing targeted multimedia content to vendor locations in a geographical area, in accordance with an embodiment of the present disclosure; and

FIG. 11 illustrates integration of customer devices into a system at a vendor location for providing multimedia content to customers, in accordance with an exemplary embodiment of the present disclosure.

Like reference numerals refer to like parts throughout the description of several views of the drawings.

### DETAILED DESCRIPTION OF THE PRESENT DISCLOSURE

For a thorough understanding of the present disclosure, refer to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a system, a method and a computer program product for providing multimedia content to customers at a vendor location. A control server and a plurality of patron devices may be provided at the vendor location. The control server receives the multimedia content from at least one multimedia content source. Each patron device of the plurality of patron devices may communicate with the control server over a communication network for receiving the multimedia content from the control server. Each patron device may display the multimedia content received from the control server for providing the multimedia content to a customer. Each patron device may be configured to receive customer input and communicate multimedia content information to the control server based on the customer input. The control server may provide the multimedia content to the each patron device based on the multimedia content information received from the each patron device.

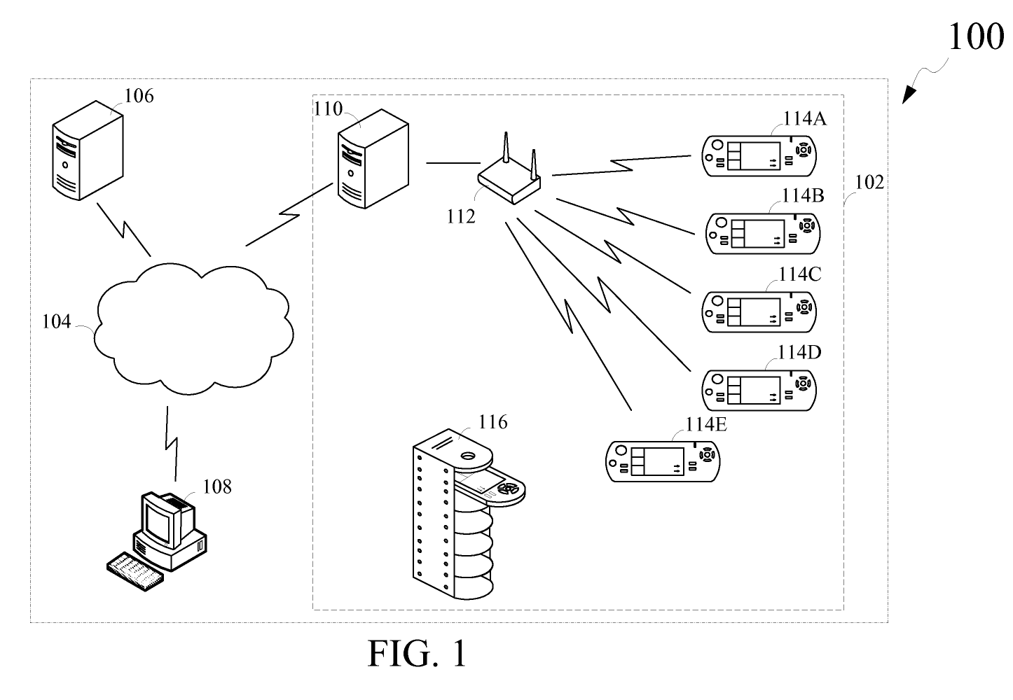

FIG. 1 illustrates an environment 100 in which various embodiments of the present disclosure may be practiced. The environment 100 includes a vendor location 102, a data network 104, a remote portal server 106 and a content source provider workstation 108. The vendor location 102 is configured with a control server 110, a wireless access point 112, a plurality of patron devices such as a patron device 114A, a patron device 114B, a patron device 114C, a patron device 114D and a patron device 114E, and a charging dock 116. The patron devices 114A, 114B, 114C, 114D and 114E will hereinafter be collectively referred to as plurality of patron devices 114. The remote portal server 106, the control server 110, the plurality of patron devices 114 and the charging dock 116 configure a system for providing multimedia content to customers at the vendor location 102. Examples of the vendor location 102 may include a restaurant, a retail store, a hospitality establishment, an automotive repair establishment, a health club, a beauty salon, a medical facility and the like.

The control server 110 and the plurality of patron devices 114 are communicably coupled using a communication network configured at the vendor location 102. The communication network may be a wireless communication network using the wireless access point 112, a wired communication network or any combination thereof. The control server 110 is further communicably coupled with the remote portal server 106 using the data network 104. Examples of the data network 104 may include the Internet, Local Area Network (LAN), wireless LAN network (WLAN) and the like. It will be obvious to a person skilled in the art that the data network 104 may include a wired communication network, a wireless communication network, or a combination thereof. The remote portal server 106 serves as a source for providing multimedia content to control servers such as the control server 110 at vendor locations such as the vendor location 102.

The multimedia content may be uploaded to the remote portal server 106 by a content source provider using the content source provider workstation 108. Examples of content source providers may include advertising agencies, gaming companies, news reporting channels and the like. Examples of the content source provider workstation 108 include, but are not limited to, a personal computer, a laptop and a personal digital assistant (PDA). As used herein, “multimedia content” shall refer to any combination of two or more of the following elements: text, image, sound, speech, animation, video, computer programs, physical movement and other sensible aspects that allow a user to interactively manipulate the presentation of the elements and/or the data presented by the elements. The multimedia content may include, but is not limited to, interactive combinations of entertainment content, informational content, advertisements, vendor location information, vendor promotions, weather information, movie clips, audio clips, physical movement (e.g. vibration, pressure, change in physical positioning, etc), odor and/or other multimedia content. Video and/or other data may by delivered as streaming video/data from the remote portal server, the control server 110 or other source, e.g. a broadcast television network. The remote portal server 106 may further be configured to manage content source provider accounts for enabling a content source provider to upload the multimedia content on the remote portal server 106. The remote portal server 106 may also be configured to manage accounts for operators of vendor locations, hereinafter referred to as vendors, for enabling vendors to update parameters such as presentation of the multimedia content on the plurality of patron devices (such as the plurality of patron devices 114.)

The remote portal server 106 may also provide content source providers, such as advertisers, tools for formatting and displaying advertisements as text, graphics, sound, video, vibration or any combination thereof. The tools may further enable advertisers to target an advertisement by geographic area, gender, age, a pre-defined radius from an advertiser's establishment, time of a day, application on a patron device of the plurality of patron devices 114, position of the advertisement on a display screen of the patron device, sequence of the advertisement in the patron device startup sequence, and the like.

The remote portal server 106 may also receive from the control server 110 an inventory of patron devices of the plurality of patron devices 114 that may have been lost, damaged or stolen at the vendor location 102. In response to the availability status associated with the patron devices 114, for example, the control server 110 may transmit a service request to the remote portal server 106 requesting fulfillment of required number of patron devices in order to maintain a pre-defined number of patron devices at the vendor location 102.

The control server 110 may be configured to receive the multimedia content from at least one multimedia content source such as the remote portal server 106. In an alternative embodiment of the present disclosure, the control server 110 receives the multimedia content from a physical computer readable medium such as a diskette, a CD-ROM, a hard disk drive, and the like. The control server 110 may further be configured to retrieve the multimedia content from internet websites and reformat the multimedia content for use on the plurality of patron devices 114. The remote portal server 106 may also direct the control server 110 to internet websites, Really Simple Syndication (RSS) or Extensible Markup Language (XML) feeds, digital databases, and such multimedia content sources, for retrieving the multimedia content and processing the multimedia content according to instructions provided by the remote portal server 106. The multimedia content may be stored in memory resident in the control server 110.

In addition to the multimedia content, the control server 110 may store applications to be executed on patron devices such as the patron device 114A. Further, system software, such as operating system software, middleware, applications and other software related to ability of the patron device 114A to function properly may be resident on the control server 110. The system software may be downloaded by the patron device 114A from the control server 110 as needed. The patron device 114A may request applications not resident in memory of the patron device 114A from the control server 110. The control server 110 may then acknowledge the request and download the requested application onto the patron device 114A. The patron device may store the application code in the memory before executing the application.

The patron device may further display the multimedia content such as advertisements and application data according to formats and procedures defined by the control server 110. The control server 110 may serve as a database for storing the application data such as data related to real estate, automobiles, movies, sports, weather, movie trailers, lottery, community events and the like. The control server 110 may also serve as a repository for multimedia content such as advertisement content of products and services being offered at the vendor location 102. Further, the control server 110 may detect and correct errors in communication with the plurality of patron devices 114. Furthermore, the control server 110 may handle events and errors occurring during operations of the plurality of patron devices 114.

The multimedia content stored on the control server 110 is delivered to customers at the vendor location 102 using the plurality of patron devices 114. As explained above, the multimedia content may be delivered to the plurality of patron devices 114 over a communication network such as a wireless communication network including at least one wireless access point such as the wireless access point 112. It will be obvious to a person skilled in the art that the wireless communication network including the wireless access point 112 is shown for exemplary purposes only and that the communication network between the control server 110 and the plurality of patron devices 114 may communicate using a wired communication network.

Each customer at the vendor location 102 may be handed a patron device, such as the patron device 114A. For instance, the patron device 114A may be handed to a customer in a waiting area at the vendor location 102, or at, or near, a point of delivery of product or service at the vendor location 102. The patron device 114A may also be handed to a customer being served, such as a customer seated at a restaurant or a lounge or under a hair dryer at a hair salon.

Each of the plurality of patron devices 114 may be charged with power from the charging dock 116 prior to handing the each of the plurality of patron devices 114 to customers. The charging dock 116 supplies power to the plurality of patron devices 114 for charging the plurality of patron devices 114. Each of the plurality of patron devices 114 may be configured to display an initial introductory series of multimedia content such as local, regional and, national advertisements, promotions and information about vendor products and services, specifics about a patron device, and the like. Patron devices of the plurality of patron devices 114 may receive the multimedia content based on the application selected by the customer. For example, the patron device 114A may receive the multimedia content related to a gaming application, whereas the patron device 114E may receive the multimedia content related to movie listings in nearby movie theatre.

Further, each of the plurality of patron devices 114 may be configured to display the multimedia content in an interactive menu-based format to the customer. For example, a patron device may display an opening screen with an icon-driven navigation menu to the customer. The customer may select an icon to enable a desired multimedia content for viewing. Icons on the opening screen may include icons for special interests of a customer, such as sports, games, weather, automotive inventory, real estate, movie schedules, community information, classifieds, charity, news, and the like. Upon selection of the icon from the navigation menu, a patron device of the plurality of patron devices 114 may indicate the customer's selection to the control server 110 through the wireless access point 112. The control server 110 may transmit information of the desired multimedia content to the patron device. The information of the multimedia content may include, for example, a software application to be executed. In one embodiment of the present disclosure, the information of the multimedia content may be present on the patron device. For example, the patron device may execute an application upon selection of an icon by the customer. Further, the patron device may request additional information from the control server 110, as required.

Each patron device of the plurality of patron devices 114 may be configured to receive customer input and communicate multimedia content information based on the customer input to the control server 110. The multimedia content information may include at least one of a customer input information and statistical information on customer usage patterns. For instance, statistics on customer's interaction with the each patron device may be captured, processed and stored by the control server 110. In addition, operational information for the vendor location 102 may also be gathered. A sequence of the customer's navigation through various applications and multimedia content may be collected by each patron device. The each patron device may deliver the multimedia content information to the control server 110 at times which are opportune for the each patron device depending on the vendor location 102, application and time. Some of the statistics collected may include, for example, total time each patron device is in service per day, time of day the each patron device is provided to the customer, length of time the each patron device is used by the customer, specific advertisements seen by customers, number of repeated advertisements, navigation that the customers follow through various menus and activities, the vendor locations such as the vendor location 102, survey results and/or time spent on each activity.

In one embodiment of the present disclosure, the control server 110 is further configured to provide the multimedia content to the plurality of patron devices 114 based on the multimedia content information. The multimedia content information may be used to target the multimedia content such as advertisements by age, gender, by application, position or order, venue or geographic region, or to spread out impressions to allow an even number of impressions by advertisers at the venue, by application, or geographic region. It will be evident to those skilled in the art that the multimedia content information may also be used to improve operational efficiency at the vendor location 102 by noting customer queue lengths and time of wait for each customer.

A patron device of the plurality of patron devices 114 may be configured as a master patron device for managing the plurality of patron devices 114. The master patron device communicates with patron devices of the plurality of patron devices 114 using the communication network. The master patron device may be configured to exhibit functionalities of the control server 110. For example, the master patron device may be configured to receive an activity status of the plurality of patron devices 114. Further, the master patron device may transmit the activity status of the plurality of patron devices 114 to the control server 110. The master patron device is capable of modifying the multimedia content received from the control server 110 for transmitting to the patron devices. Further, the master patron device may be used by the vendor for advertising vendor products, vendor services or ongoing vendor promotion schemes. For example, a restaurant owner may be offering a special discount on a particular beverage, and may utilize the master patron device to advertise the discount on patron devices handed to the customers.

The control server 110 and the master patron device may also include capability to provide a sequence of vibration patterns to the plurality of patron devices 114. The master patron device may also provide the vibration patterns directly or through the control server 110. Vibration may be provided to the patron device such as the patron device 114A for alerting a customer using the patron device 114A of availability of a product or service. The vibration may also be provided for alerting maintenance personnel at the vendor location 102 with regard to drifting of the patron device 114A out of a coverage area for receiving signals from the wireless access point 112. The vibration patterns may be of increasing or decreasing energy levels. Further, energy levels of one or more vibration motors in a patron device, such as the patron device 114B may be different from energy levels of a vibration motor that may be installed in another patron device, such as the patron device 114D. The master patron device may be capable of providing vibration patterns that go from a state of no vibration to a particular energy level of vibration or vibration patterns that go in a reverse manner. Also, multiple independently operated vibration motors may be provided in a single patron device for providing desired vibration responses, patterns and/or levels.

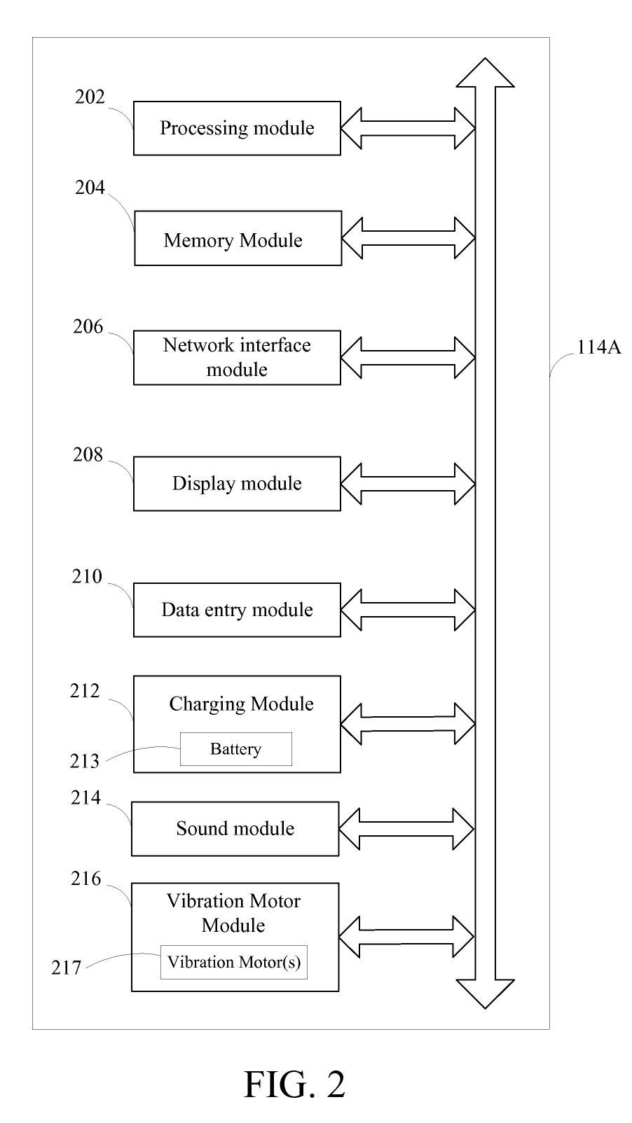

Various features of the system will be explained in conjunction with FIGS. 2-11.

FIG. 2 is a block diagram of the patron device 114A of the plurality of patron devices 114 of FIG. 1, in accordance with an embodiment of the present disclosure. The patron device 114A may be a mobile handheld device including a processing module 202, a memory module 204, a network interface module 206, a display module 208, a data entry module 210, a charging module 212, a sound module 214 and a vibration motor module 216. It will be evident to those skilled in the art that the patron device 114A is illustrated for exemplary purpose only and that any patron device of the plurality of patron devices 114 may include modules similar to those illustrated for the patron device 114A.

The processing module 202 executes instructions for performing various functionalities of the patron device 114A. For example, the processing module 202 executes various software algorithms such as those for operating system software, application software for multimedia content, and the like. The processing module 202 may be implemented in form of an Integrated Chip (IC) for executing the instructions for performing functionalities of the patron device 114A. The processing module 202 may retrieve the software algorithms to be executed from the memory module 204.

The memory module 204 of the patron device 114A may be configured to load the software algorithms when the patron device 114A is inserted in the charging dock 116 for charging. In another embodiment of the present disclosure, the patron device 114A may load the software algorithms, such as application software for the multimedia content to be executed, from the control server 110 (not shown) into the memory module 204 when a customer using the patron device 114A makes a selection of desired multimedia content. Examples of the memory module 204 include computer readable media, such as but not limited to, a flash memory, a cache memory, a Random Access Memory (RAM) and a Read Only Memory (ROM). The memory module 204 may also be configured to store the customer inputs to provide the multimedia content information to the control server 110.

The memory module 204 is communicably coupled to the network interface module 206 for exchanging the multimedia content and the multimedia content information with the control server 110. The memory module 204 may be configured to be reset on being inserted into the charging dock 116. Resetting the memory module 204 may include clearing the customer input information stored in the memory module 204. The customer input information may be cleared from the memory module 204 after transmitting the multimedia content information stored in the memory module 204 to the control server 110 using the network interface module 206.

The network interface module 206 of the patron device 114A is configured to communicate with the wireless access point 112 for communicating with the control server 110. Examples of the network interface module 206 include, but are not limited to, a modem and a Network Interface Card (NIC). The network interface module 206 may include a transmitter module (not shown) for transmitting the multimedia content information to the control server 110 and may include a receiver module (not shown) for receiving the multimedia content from the control server 110. The multimedia content received from the control server 110 may be executed by the processing unit 202 and displayed to a customer using the display module 208.

The display module 208 includes a display screen and is configured to display the multimedia content including text, graphics, animation, videos, and the like. The display module 208 is communicably coupled to the processing module 202 for displaying the multimedia content for the customer on the display screen. Examples of the display screen may include a Liquid Crystal Display (LCD), a Cathode Ray Tube (CRT) monitor, a plasma display, and the like. The display screen of the display module 208 is enabled to display the multimedia content that may be selected by the customer. The customer may indicate a selection of the multimedia content to be viewed by using the data entry module 210.

The data entry module 210 is configured to enable a customer using the patron device 114A to make a selection of the multimedia content. Examples of the data entry module 210 may include navigation keys, soft keys, a keyboard, a mouse, a joystick and a touch screen menu selector. The data entry module 210 is communicably coupled to the processing module 202 for communicating the customer's selection to the processing module 202. The processing module 202 may further request the desired multimedia content from the memory module 204 or from the control server 110 through the network interface module 206.

The charging module 212 includes a battery unit 213 and requisite circuit connections for connecting the battery unit to the charging dock 116. The patron device 114A recharges the battery unit using power supplied by the charging dock 116. The patron device 114A may further include light emitting diodes (not shown) for displaying a charge status of the battery unit.

The sound module 214 may include a sound generation device configured to provide an audible output associated with multimedia content, e.g. a tone, music, speech, sound effects, etc. The sound module 214 is communicably coupled to the processing module 202 for generating the audible output. The sound generation module may be enabled to generate the audible output according to a selection by a customer. The customer may indicate a selection of audible multimedia content to be listened to by using the data entry module 210.

The patron device 114A may also include a vibration motor module 216 including one or more vibration motors 217 for alerting a customer on an occurrence of an event, such as, completion of waiting time for a product or service desired by the customer. The vibration motor module 216 is communicably coupled to the processing module 202 for generating the vibration output. Multiple independently operated vibration motors may be included in the vibration motor module 216 for providing desired vibration responses, patterns and/or levels.

Further, it will be evident to those skilled in the art that each component of the patron device 114A such as the processing module 202, the memory module 204, the network interface module 206, the display module 208, the data entry module 210, the charging module 212, the sound module 214, and the vibration motor module 216 may be implemented as a hardware module, a software module, a firmware module, or any combination thereof. Furthermore, it will be obvious to those skilled in the art that the patron device 114A may include requisite electrical connections for communicably coupling the various components of the patron device 114A.

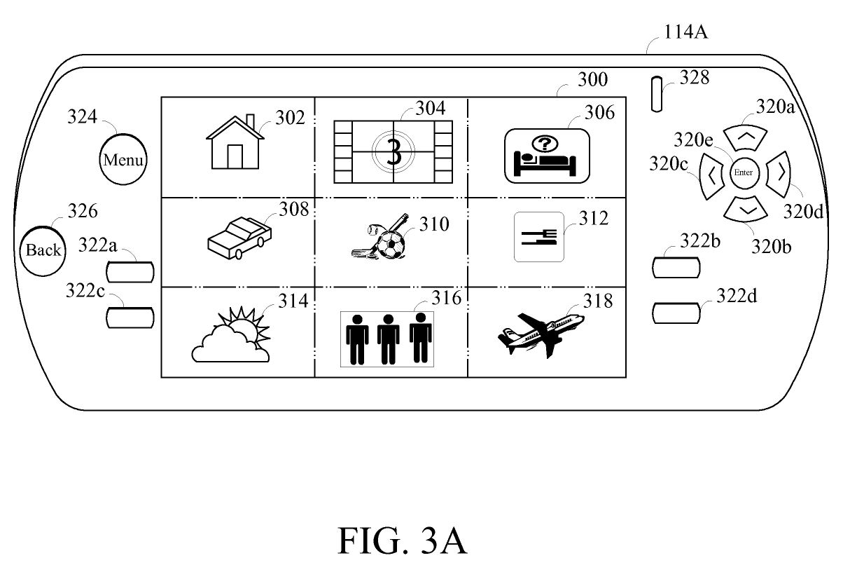

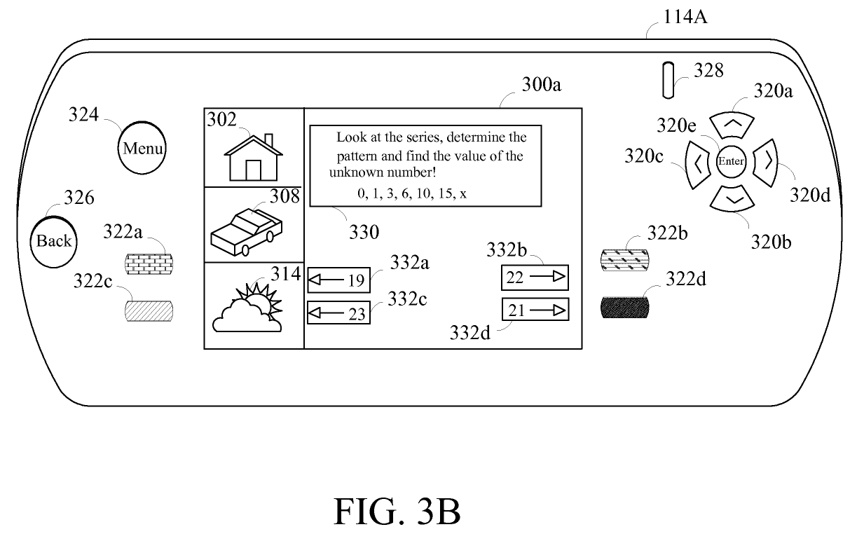

FIG. 3A illustrates an exemplary opening screen 300 displayed on the display screen of the patron device 114A, in accordance with an embodiment of the present disclosure. As explained in conjunction with FIGS. 1 and 2, each patron device of the plurality of patron devices 114 may be configured to display multimedia content in an interactive menu-based format. The exemplary opening screen 300 depicts icons 302-318 representing various menu options for the customers. In FIG. 3A, icon 302 represents menu option for real-estate related information, icon 304 represents menu option for movie listings, icon 306 represents menu option relating to healthcare services, icon 308 represents menu option relating to automobiles for information such as car prices in a locality and options for renting automobiles, icon 310 represents menu option for sports news and sports games such as trivia games, icon 312 represents menu option for eating and dining services, icon 314 represents menu option for weather related information, icon 316 represents menu options for information relating to community networks in the locality and icon 318 represents menu option for air travel reservations and air ticket booking information. It will be evident to a person skilled in the art that the choice of menu-options displayed in the exemplary opening screen 300 may vary and may be chosen by a vendor based on the product or service being offered at a vendor location, such as the vendor location 102 of FIG. 1.

The patron device 114A may further be configured to insert business-related information such as advertisements, promotions, and information about products and services, at various entry points within the multimedia content selected by the customer. The entry points refer to specific durations, such as a transition between applications being displayed on the display screen. The business-related information may be in form of graphics, still images, audio, video, sound and/or vibration. The insertion of the business-related information may also be allowed at specific slots within the multimedia content. For example, a background in a trivia game may be replaced by an advertiser's content or logo. Banners, graphics, still images, video and such other insertions may be embedded within a software application for providing the business-related information. The business-related information may be displayed at any frequency and at any time of a day on the patron device 114A. Further, the business-related information may be changed and redisplayed at any time of a day.

In one embodiment of the present disclosure, the patron device 114A may utilize advertising software algorithms for managing the business-related information provided by the vendor. An advertising software algorithm may permit rotation of the business-related information amongst applications corresponding to the various menu options. For example, the business-related information such as advertisements may be rotated between games and movies options selected by a customer. The rotation of an advertisement may be based on specific advertiser-related requirements on viewing of the advertisement, to meet agreements on a number of viewings of the advertisement by application, position or order, venue or geographic region, or to spread out promotions to allow an even number of promotions by advertisers at the venue, by application, or geographic region. It will be evident to those skilled in the art that the advertising software algorithm may be configured to provide a variety of such options for providing the business-related information.

As explained in conjunction with FIGS. 1 and 2, the patron device 114A is configured to store customer input for providing the multimedia content information including at least one of customer input information and statistical information on customer usage patterns. The multimedia content information may be stored on the patron device 114A with time and date information and may then be delivered to the control server 110 for aggregation, analysis and formatting purposes. The control server 110 may then transmit the statistical information to the remote portal server 106 of FIG. 1. The statistical information may be used by an advertiser, a vendor, or any such other content source provider to tune the multimedia content, display screen transitions, backgrounds and insertion slots for inserting the business-related information. The statistical information may also be used to determine age related usage and allow appropriate insertion of the multimedia content that is targeted to a specific age group.

In FIG. 3A, the patron device 114A is further configured to receive the customer input using navigation keys such as a screen-up key 320a, a screen-down key 320b, a screen-left key 320c, a screen-right key 320d and a screen selection key 320e. The navigation keys 320a, 320b, 320c, 320d and 320e will hereinafter be collectively referred to as ‘navigation keys 320’. The navigation keys 320 may be used to traverse the menu options displayed on the display screen of the patron device 114A. Further, soft keys such as a soft key 322a, a soft key 322b, a soft key 322c and a soft key 322d are provided to facilitate easy navigation between the various menu options. The soft keys 322a, 322b, 322c and 322d will hereinafter be collectively referred to as soft keys 322. In addition to the navigation keys 320 and the soft keys 322, opening screen key 324 and back-screen key 326 are provided for displaying the opening screen 300 and returning to a previous display screen respectively. In FIG. 3A, a Light Emitting Diode (LED) 328 is also provided to display a system availability and connectivity for the patron device 114A. For example, the LED 328 may be configured to display green color indicating that the system is available and in communication with the server and red color for alerting the vendor and/or the customer that the system is not available or connected to the server.

The patron device 114A enables a customer to select an icon by using one of the navigation keys 320 and the soft keys 322 provided on the patron device. It will be evident to those skilled in the art that the patron device 114A may alternatively include a touch screen interface for permitting the customer to select an icon using a finger touch, a stylus touch and the like.

Upon selection of an icon from the various menu options, the patron device 114A may display the multimedia content corresponding to the selected icon. Each patron device may display different multimedia content in response to patron menu selections. An example of the multimedia content displayed on selection of an icon is explained in conjunction with FIG. 3B. As explained in conjunction with FIGS. 1 and 2, the multimedia content may be resident in the memory module 204 of the patron device 114A or may be required to be downloaded from the control server 110. Further, the patron device 114A may format the multimedia content provided by the control server 110 and may represent the multimedia content to the customer in form of vibration, sound, video, graphics, or any combination thereof.

FIG. 3B illustrates an exemplary application display screen 300a depicting multimedia content corresponding to an application selected by a customer by using an icon of the icons 302-318 of FIG. 3A, in accordance with an embodiment of the present disclosure. As explained in conjunction with FIG. 3A, the exemplary opening screen 300 depicts the icons 302-318 representing the various menu options for the customers. The icon 310 represents menu option for sports news and sports games such as trivia games. On selection of the icon 310 by the customer using one of the navigation keys 320 and the soft keys 322, an application, such as a trivia game application, may be invoked and the exemplary application display screen 300a may be displayed. The exemplary application display screen 300a includes a text box 330 including a trivia question ‘Look at the series, determine the pattern and find the value of the unknown number! 0, 1, 3, 6, 10, 15, x’. In addition to the text box 330, four options 332a, 332b, 332c and 332d including numbers 19, 22, 23 and 21 respectively are displayed. The four options 332a, 332b, 332c and 332d are placed adjacent to the soft keys 322a, 322b, 322c and 322d respectively for facilitating ease of selection of an option by the customer. The four options 332a, 332b, 332c and 332d represent answer options for the trivia question displayed in the text box 330.

The soft keys 322 may have light source, e.g. LEDs, configured beneath or adjacent the soft keys 322. The LEDs may be chosen to display a single color or a different color for each of the LEDs. Light emitted by the LEDs may be visible through slits designed within the soft keys 322. An LED beneath a soft key such as the soft key 322a may be lit to indicate that the soft key is an active input, and if the soft key is depressed by the customer, the patron device 114A will respond to the customer input. The soft keys 322 allow for reduction in number of customer keystrokes by the customer

One or more of soft keys may be established as an active user input in response to the multi-media content. For example, the multimedia content, such as the trivia game application, as depicted in FIG. 3B, may require the customer to select any one of the four options by selecting one of the soft keys 322 along the display screen. The LEDs beneath the soft keys 322 may be lit by the patron device to indicate that the soft keys 322 are active. The customer may select any of the soft keys 322 to indicate an answer in the trivia game. Compared to navigation keys 320, the soft keys 322 may provide a time efficient and easy way of accepting the customer input, such as an option in the trivia game application Time efficiency may be an important consideration for gaming applications. Alternatively, the customer may use the navigation keys 320 to navigate to one of the four options and then select an option of the four options. The soft keys 322 may be utilized for applications, such as selection of automobiles, simple yes/no selections for questionnaires, selecting display of previous or next view of a real estate property; requesting more information on a specific item, and the like.

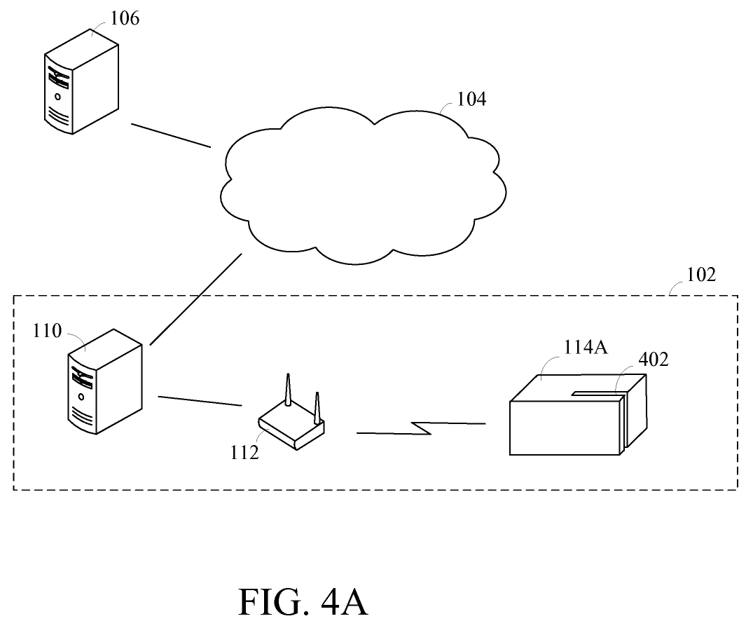

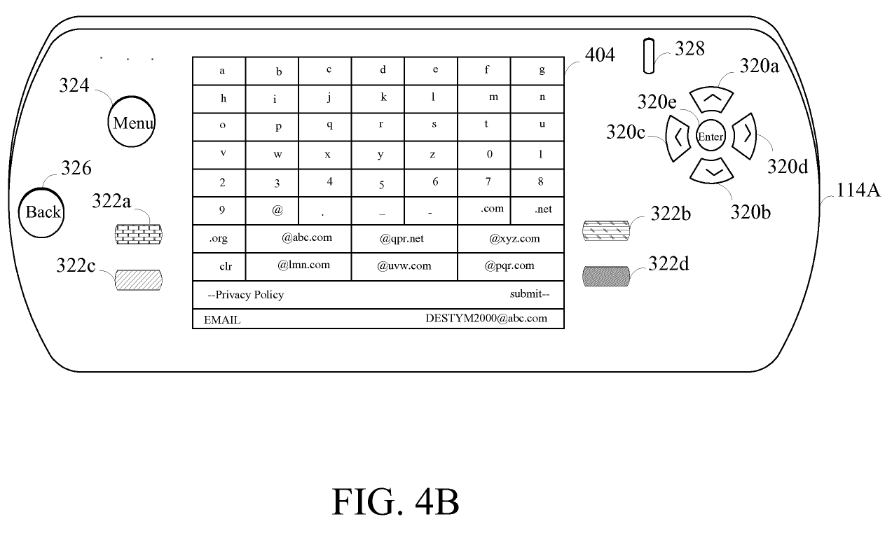

FIGS. 4A and 4B illustrate the patron device 114A configured with a card reader for integrating with a Point-of-Sale (POS) system (not shown) at a vendor location, such as the vendor location 102 of FIG. 1, and an email input display screen 404 of the patron device 114A configured for receiving customer email information respectively, in accordance with an exemplary embodiment of the present disclosure. FIG. 4A illustrates the patron device 114A configured with a card reader for facilitating customer payment at the POS system at the vendor location 102. The POS system may be an area at the vendor location 102 reserved for conducting transactions. Examples of a vendor location with POS system may include a supermarket, a restaurant, a hotel, a hospitality establishment, and the like. In FIG. 4A, the patron device 114A is used for performing transactions with the POS system.

As explained in conjunction with FIGS. 3A and 3B, the various menu options provide access to information, such as real estate information, information regarding automobiles, air-travel reservation information and the like. The customer may select one of the various menu options and may proceed to purchase a corresponding product or service using a customer credit card. The card reader in the patron device 114A may allow the customer to easily enter credit card information by swiping the customer credit card in a slot 402 provided in the patron device 114A. The network interface module 206 of the patron device 114A may be configured to encrypt the credit card information and transmit the credit card information to the POS system at the vendor location 102. The credit card information may be transmitted to the control server 110. The control server 110 may forward the credit card information to a corresponding service or product supplier, for example, a vendor, a salesperson, or a merchant. The control server 110 may be integrated with the POS system at the vendor location 102 to allow for local purchases of the products or services. Further, the multimedia content, such as, information, promotions, or coupons displayed by the patron device 114A or requested by a customer using the patron device 114A may be printed via the POS system.

For example, a customer dining at a restaurant may request a movie ticket for a movie being screened at a movie theatre near the restaurant. The request may be routed from the control server 110 to a POS system at the movie theatre either directly or through the remote portal server 106 over the data network 104. The POS system at the movie theatre may then service the request and route a response back to the POS system at the vendor location 102 for printing on a printer at the POS system at the vendor location 102.

Further, purchases at the vendor location 102 may be made directly from the patron device 114A in use by a customer. For example, a customer using the patron device 114A at the vendor location 102, such as a restaurant may request an item from a menu and proceed to pay for the item by swiping the customer credit card in the slot 402 provided in the patron device 114A. It will be evident to those skilled in the art that similar arrangements for integrating with the POS system may be included in the each patron device such as including a scanner for processing the electronic transactions.

FIG. 4B illustrates the email input display screen 404 of the patron device 114A configured for receiving customer email information, in accordance with an embodiment of the present disclosure. The email input display screen 404 depicts letters from A-Z, numbers from 1-9, special characters, a choice of selected domain names such as abc.com, pqr.com and the like, for receiving the customer email information. The customer may provide the customer email information by selecting the soft keys 322 corresponding to an email address of the customer or may use the navigation keys 320 to input the customer email information. The customer may provide the customer email information for a variety of reasons, such as providing feedback for a product or service, requesting information about promotional offerings and the like. The customer email information provided by the customer is sent to the control server 110, which may then route the customer email information to the remote portal server 106 or to a control server at a vendor location offering the product or service for which the information is requested by the customer.

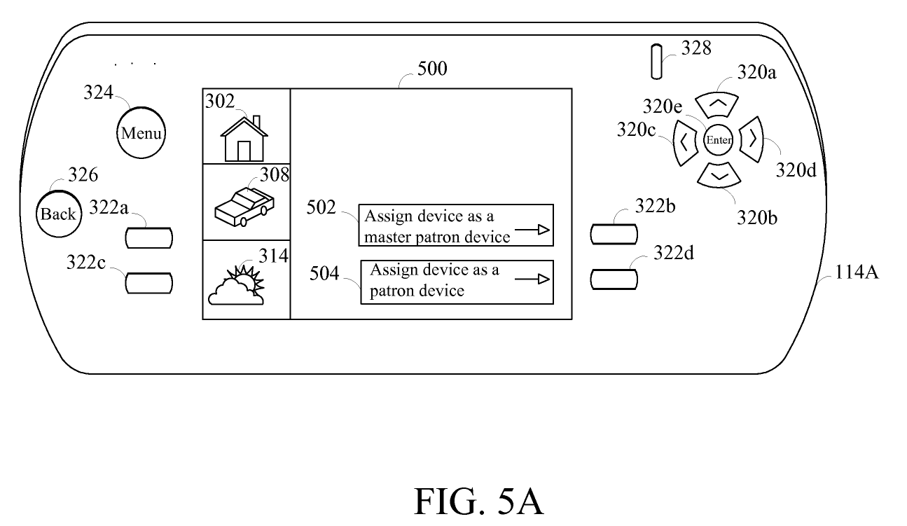

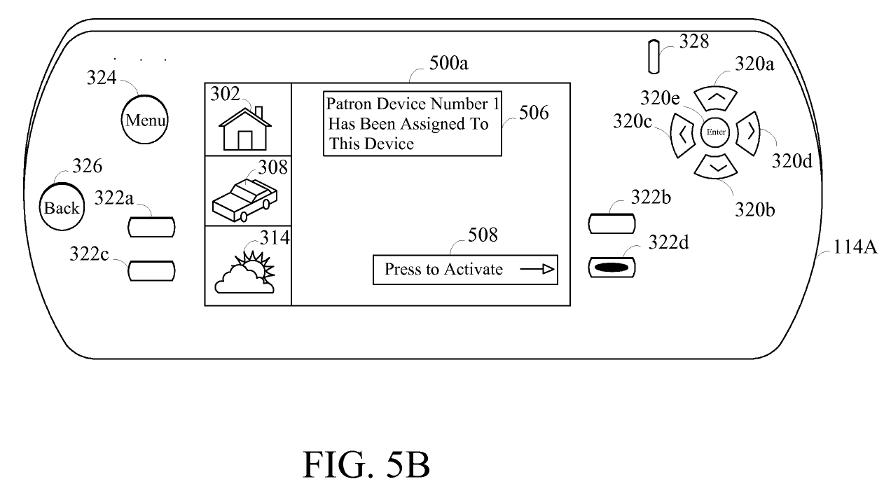

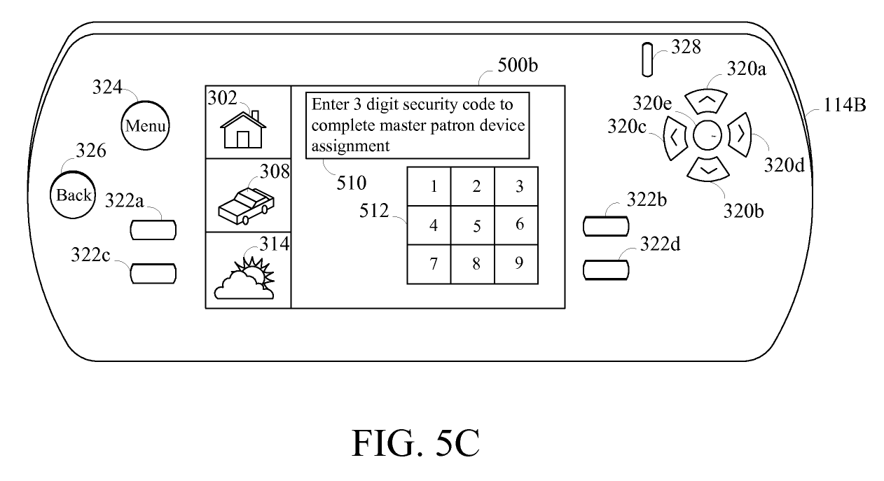

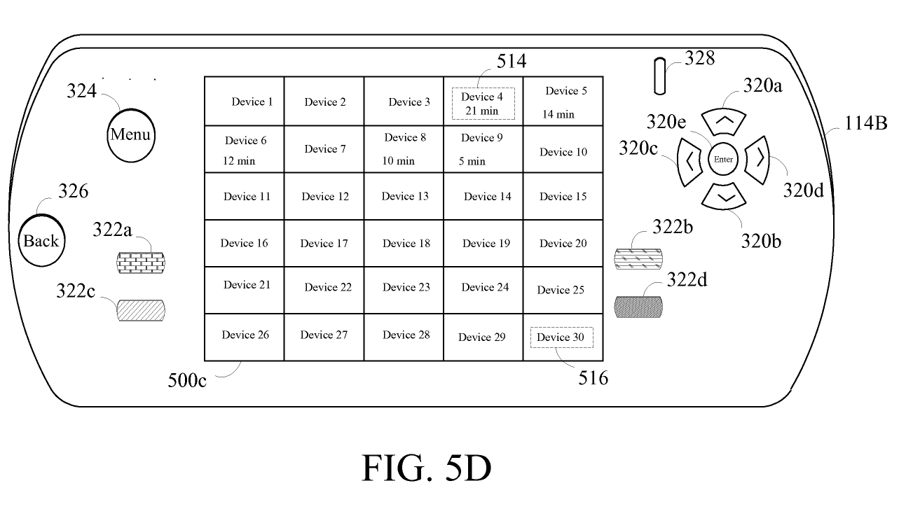

FIGS. 5A, 5B, 5C and 5D illustrate assignment of patron devices of the plurality of patron devices 114 of FIG. 1, in accordance with an embodiment of the present disclosure. FIG. 5A illustrates an exemplary assignment screen 500 displayed on the patron device 114A of the plurality of patron devices 114 after removal of the patron device 114A from the charging dock 116. The exemplary assignment screen 500 displays a text box 502 including text, ‘Assign device as a master patron device’, and a text box 504 including text, ‘Assign device as a patron device’, for assigning the patron device as a master patron device and as a patron device, respectively. Alternatively, a sound module in the patron device 114A may notify a vendor that a selection needs to be made for operating the patron device 114A as a master patron device or as a patron device, when the patron device 114A is removed from the charging dock 116. The text box 502 and the text box 504 are displayed adjacent to soft key 322b and soft key 322d for facilitating ease of assignment of the patron device as a master patron device or as a patron device. Any one of the plurality of patron devices 114 may be configured for operation as the master patron device.

FIG. 5B illustrates an exemplary identifier assignment display screen 500a displayed on the patron device 114A when the patron device 114A is assigned a patron device identifier. The patron device may be assigned the patron device identifier dynamically when the patron device 114A is available for use by a customer. A patron device may be said to be available for use by a customer when the patron device is determined to be available by the control server and software resident on the patron device and removed from the charging dock 116. The patron device identifier may be utilized by a control server such as the control server 110 or the master patron device, to identify the patron device from the plurality of patron devices 114.

In FIG. 5B, the identifier assignment display screen 500a displays a text box 506 including text, ‘Patron device number 1 has been assigned to this device’, and a text box 508 including text, ‘Press to activate’, for informing the customer of the patron device identifier assigned to the patron device 114A and requesting the activation of the patron device 114A, respectively. The customer may select the soft key 322d adjacent to the text box 508 for activating the patron device 114A for use. The patron device may then display the exemplary opening screen 300 explained in conjunction with FIG. 3A. Dynamically assigning the patron device identifier for the patron device 114A alleviates need for hard coded numbers to be set for the patron device 114A.

FIG. 5C illustrates an exemplary master patron device assignment screen 500b displayed on a patron device such as the patron device 114B when the patron device 114B is assigned as a master patron device by a vendor. The patron device 114B may be assigned as the master patron device by inputting a security code. The security code may be required to be entered for enabling a patron device to perform the functionalities of the master patron device as explained in conjunction with FIG. 1 such as administering the multimedia content, controlling the plurality of patron devices 114, and other similar functions that may be performed by the master patron device. As shown in FIG. 5C, the exemplary master patron device assignment screen 500b displays a text box 510 including text, ‘Enter 3 digit security code to complete master patron device assignment’, and a text box 512 including numbers from 1-9, for entering the security code and providing options to the vendor. It will be obvious to a person ordinarily skilled in the art that the security code may be formed from alphanumeric characters, special characters, or any combination thereof. The vendor may use the navigation keys 320 or the soft keys 322 to enter the security code. Alternatively, the vendor may use a touch screen feature of the patron device 114B to enter the security code.

FIG. 5D illustrates an exemplary activity status display screen 500c displayed on the master patron device. The master control patron device may be used as a management device for providing operator based features to the vendor. As shown in FIG. 5D, the exemplary activity status display screen 500c of the master patron device may display activity status information of the plurality of patron devices 114 to the vendor. The activity status information of each patron device of the plurality of patron devices 114 is indicated on the exemplary activity status display screen 500c in text boxes. For example, text box 514 depicts the activity status information of a patron device that is assigned a patron device identifier 4. The activity status information may further include information such as a time for which a patron device is in service. For instance, the text box 514 includes text '21 minutes' indicating that the patron device with patron device identifier 4 has been in service for 21 minutes. A text box 516 not including time information status for a patron device identified with the patron device identifier 30 may indicate that a patron device is unavailable for use and may indicate that the patron device is being serviced at the charging dock 116. In general, the activity status information of the plurality of patron devices 114 may indicate whether a patron device is in service or out of service. Further, the activity status information may indicate a waiting time for a customer using a patron device. In one embodiment of the present disclosure, the waiting time for a patron device in service may indicate that the customer has been waiting 5 minutes longer than a time period that was originally anticipated by a vendor for serving the customer. In another embodiment of the present disclosure, the waiting time may indicate time remaining before the user is served by the vendor.

The activity status information may be displayed to the vendor as color coded icons. For example, a yellow colored icon for a patron device in service may indicate that the customer has been waiting for a pre-defined number of minutes longer than time conveyed to the customer by the vendor, a green colored icon for a patron device may indicate that a time period for which the customer has held the patron device is still within a window of time offered by the vendor, and a red colored icon for a patron device may indicate that the customer has held the patron device for pre-defined minutes in addition to the time committed by the vendor. The master patron device may permit the vendor, to set parameters for the color coded icons. Further, the master patron device may permit the vendor to customize other features and functions of the master patron device.

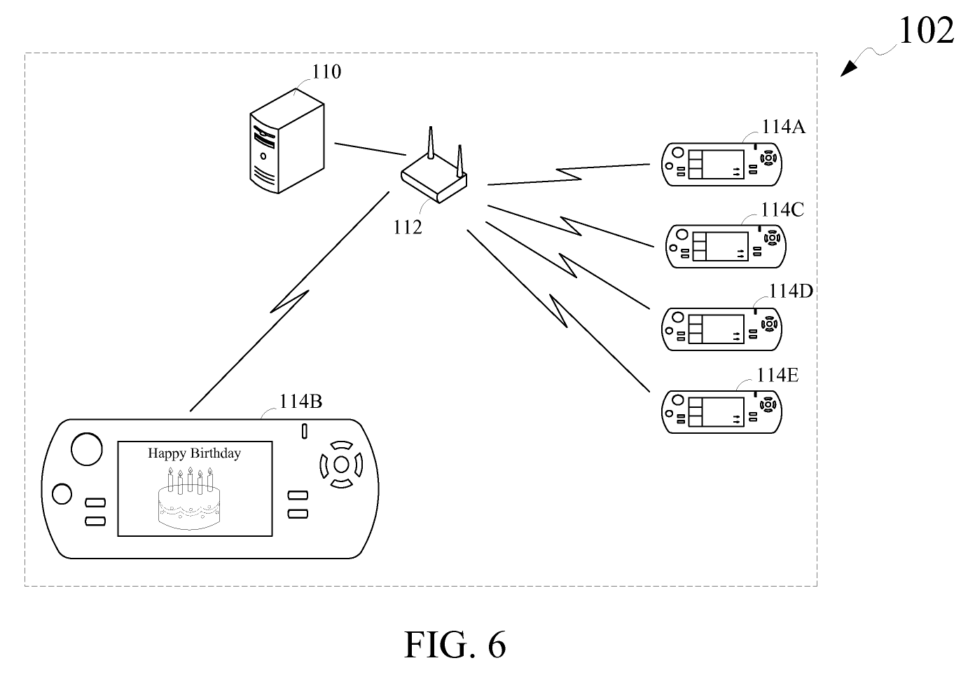

FIG. 6 depicts the vendor location 102 with the master patron device, such as the patron device 114B providing information of special events to patron devices, such as the plurality of patron devices 114, according to an exemplary embodiment of the present disclosure. The master patron device may be configured by the vendor to provide the information of special events to patron devices of the plurality of patron devices 114. For example, if there is a birthday party at the vendor location 102, such as a restaurant or a hotel, a name of birthday person could be displayed on the patron devices with appropriate sounds, graphics and vibrations, for example, balloons bursting and fireworks going off. Examples of the special events may include, but are not limited to, holidays, festivals and anniversaries.

The vendor may upload the information of the special events through a remote portal server, such as the remote portal server 106 of FIG. 1 by connecting a personal computer to the Internet or through the master control device. Special multimedia images, graphics, sounds and/or vibration patterns may be stored in the master patron device and sent to the plurality of patron devices from the master patron device or through the control server 110.

FIG. 6 also illustrates an exemplary promotion of a special event at the vendor location 102 of FIG. 1 using the master patron device, in accordance with an embodiment of the present disclosure. The special event in FIG. 6 is a birthday celebration and the master patron device is configured to generate a happy birthday multimedia presentation and transmit the multimedia presentation to the control server 110. The control server 110 may then send the multimedia presentation to the plurality of patron devices 114 configured to receive the multimedia presentation. The vendor may similarly use the master patron device to promote other special events, or even promote daily specials on products or services being offered at the vendor location 102. For example, the vendor may need to advertise a special offering on a particular beer, a discount on a hair salon product, a sudden change in operator hours or a special discount on an automobile oil change. The master patron device may modify an existing multimedia content received from the control server 110 or from the remote portal server 106 of FIG. 1 (not shown) and transmit the modified multimedia content to the plurality of patron devices 114 to promote special events at the vendor location 102.

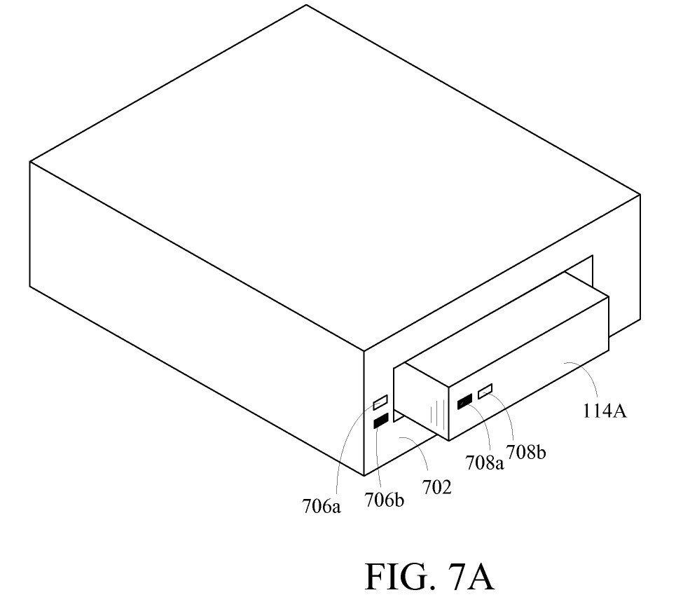

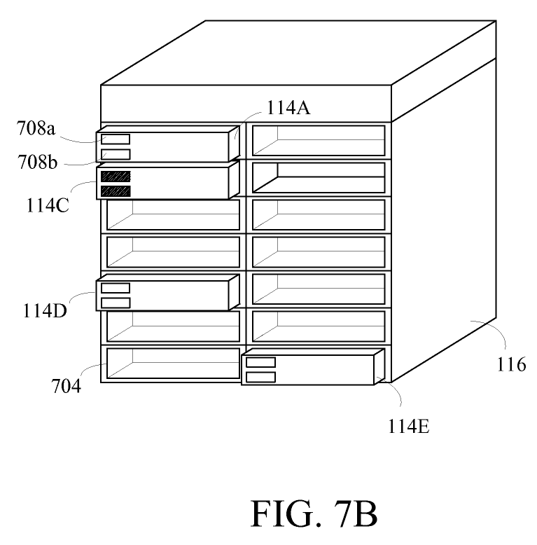

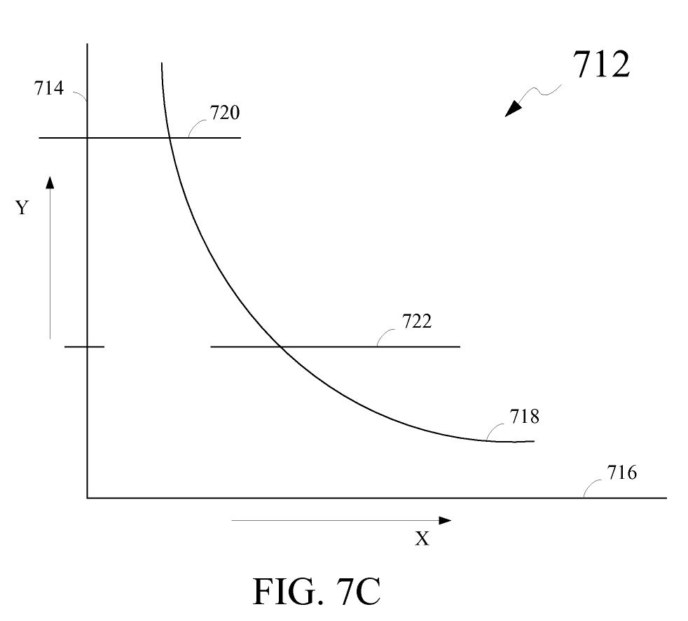

FIGS. 7A, 7B and 7C refer to charging of patron devices of the plurality of patron devices 114, in accordance with an embodiment of the present disclosure. As explained in conjunction with FIG. 1, at least one charging dock, such as the charging dock 116 is provided at a vendor location, such as the vendor location 102 of FIG. 1 for charging the patron devices. The charging dock 116 supplies power to the patron devices for charging the patron devices. The charging dock 116 may include charging dock trays to physically support the patron devices when the patron devices are inserted into the charging dock 116. FIG. 7A illustrates a charging dock tray 702 receiving the patron device 114A for charging the patron device 114A in accordance with an embodiment of the present disclosure. FIG. 7B illustrates the charging dock 116 for supplying power to the plurality of patron devices 114, in accordance with an embodiment of the present disclosure. FIG. 7C illustrates a plot of variation in maximum available battery charge of the patron device 114A with variation in time, in accordance with an embodiment of the present disclosure.

As explained in conjunction with FIG. 2, the charging module 212 of the patron device 114A may include a battery unit and requisite circuit connections for connecting the battery unit to the charging dock 116. The patron device 114A recharges the battery unit using power supplied by the charging dock 116. The charging dock tray 702 may be configured with at least one light source, e.g. an LED, for indicating an availability status of the patron device 114A. In addition or alternatively, the patron device 114A may be configured with the at least one light source, e.g. an LED, for indicating the availability status of the patron device 114A. In FIG. 7A, LED 706a and LED 706b are provided on the charging dock tray 702, and LED 708a and LED 708b are provided on the patron device 114A for indicating the availability status of the patron device 114A. LEDs 706a and 706b are hereinafter collectively referred to as ‘charging dock LEDs 706’. LEDs 708a and 708b are hereinafter collectively referred to as ‘patron device LEDs 708’.

The availability status of the patron device 114A may indicate availability of the patron device 114A to a vendor for servicing a customer at the vendor location 102. The patron device 114A may be available to service a customer at the vendor location 102, based on default criteria set by the control server and/or criteria determined by the vendor. The vendor may alter the default criteria set by the control server using the control server 110 or the master patron device. If the criteria are satisfied by the patron device 114A, the availability status of the patron device 114A may be reflected by at least one of the charging dock LEDs 706 and the patron device LEDs 708. In addition to a charge status of the patron device 114A, the criteria for determining the availability of the patron device 114A for service may include at least one of completion of upload of the multimedia content information such as statistics and other stored parameters from the patron device 114A to the control server 110; completion of module checks; completion of boot operations or operating system updates for the patron device 114A; authorization from the control server 110 for removal of the patron device 114A from the charging dock tray 702. The module checks may be performed to check whether various modules of the patron device 114A are operational. Examples of module checks may include, a check of the memory module 204 such as Random Access Memory (RAM) and flash memory, a check to determine whether a boot sequence of the processing module 202 is complete, a check to determine whether power level of a battery unit internal to the patron device 114A is at or above a threshold value, a check to determine whether the network interface module 206 is active and communicating with the control server 110, and the like. When the criteria are satisfied by the patron device 114A, at least one of the charging dock LEDs 706 and the patron device LEDs 708 may reflect an availability status of the patron device 114A as available.

FIG. 7B illustrates the charging dock 116 including a plurality of charging dock trays for supplying power to patron devices of the plurality of patron devices 114. As explained in conjunction with FIG. 7A, LEDs are provided on the patron devices and on the plurality of charging dock trays, for indicating a charge status of the patron devices. On the charging dock 116, LEDs may be positioned adjacent to a charging dock tray 704, such as the charging dock tray 702, for holding the patron device 114A while the patron device 114A is being charged. In one embodiment of the present disclosure, LEDs on the charging dock 116 corresponding to a patron device may appear in any visible location on the charging dock 116. As explained in conjunction with FIG. 7A, the LEDs provided on the patron device 114A are used to indicate the availability status of the patron device 114A.

In FIGS. 7A and 7B, the LEDs provided on the patron devices, such as the patron device LEDs 708 provided on the patron device 114A, may be single color LEDs or multicolored LEDs. Multiple colors of the multicolored LEDs may be utilized to indicate a current availability status of a patron device. For instance, an LED may be lit red on the patron device to indicate that the patron device is not available for service; or may be lit green to indicate that the patron device is available for service; or may be lit yellow or may flash to indicate that certain updates are in process. An additional LED may be provided on the patron device 114A to indicate connectivity of the patron device 114A with the control server 110. It will be evident to a person skilled in the art that multiple single color LEDs may be utilized or a single multicolored LED may be provided in the patron device 114A to indicate the current availability status of the patron device 114A.

Further, the charging dock LEDs 706 may be powered by patron devices corresponding to the charging dock LEDs 706 when the patron devices are inserted into the charging dock 116. A patron device of the plurality of patron devices 114 may be inserted into the charging dock tray such as the charging dock tray 702 of the charging dock 116 and charged using a connector. Signals from the connector may be routed to a visible position adjacent to a charging dock tray of the charging dock 116 in which the patron device is inserted. Alternatively, the signals from the connector may be routed to any visible position on the charging dock 116. Thereby, each patron device while inserted into the charging dock 116 is capable of indicating an availability status of the each patron device by lighting the charging dock LEDs 706 located at a visible location on the charging dock 116. The charging dock LEDs 706 may further indicate a charge status in addition to the availability status as explained in conjunction with FIG. 3A.

In one embodiment of the present disclosure, an LED panel (not shown) may be provided on top of the charging dock 116. The LED panel may have LEDs corresponding to the plurality of patron devices 114 for indicating the availability status of patron devices of the plurality of patron devices 114. The LEDs on the LED panel may be powered by signals routed individually through wires from the patron devices to the LED panel.

In one embodiment of the present disclosure, the availability status of the patron devices may be controlled by the control server 110. The control server 110 may control when a patron device lights an LED corresponding to the patron device. Each patron device of the plurality of patron devices 114 communicates availability status of the each patron device to the control server 110. The control server 110 may utilize the information of the availability status of the patron devices for directing a patron device to set an LED status of the patron device to available. For example, if the patron devices are docked in the charging dock 116, as shown in FIG. 7B, the control server 110 may direct only one patron device to light a corresponding LED green, to indicate an available status. The control server 110 may direct remaining patron devices to light corresponding LEDs red to indicate unavailability for use. In one embodiment of the present disclosure, the control server 110 may direct the patron devices to display an appropriate availability status based on number of patron devices in service.

The control server 110 may maximize utilization of the plurality of patron devices 114 by directing the patron devices to set availability status of the patron devices. A patron device, such as the patron device 114A, may have utilized a memory module, such as the memory module 204, to full capacity by storing customer input or stored parameters and statistics accepted from a customer. The customer input or stored parameters and statistics may be uploaded to the control server 110 and the memory module 204 of the patron device may be cleared for reuse. In one embodiment of the present disclosure, patron devices of the plurality of patron devices 114 with a charge status of the battery unit at, or nearing, a threshold value may be held in the charging dock 116 by lighting corresponding LEDs red until the patron devices are fully charged. In another embodiment of the present disclosure, the control server 110 may check whether a boot code and operating system updates have been successfully downloaded to a patron device before authorizing the patron device to indicate availability of the patron device for use. The control server 110 may also check whether communication with the patron device is established before setting a status of the patron device as available. The control server 110 may further check whether a memory module of the each patron device has been fully reset upon insertion into the charging dock 116 and that the each patron device is set to a usable state prior to making the each patron device available for use.

In one embodiment of the present disclosure, the each patron device monitors current drawn by the each patron device from a battery unit internal to the each patron device. The each patron device stores information of total amount of current drawn from a fully charged battery unit of the patron device before a voltage of the battery unit reaches a threshold value. The threshold value of the voltage refers to a minimum value of voltage for enabling functioning of a patron device. The information from each patron device is collected and stored by therein. The control server 110 may monitor a maximum available charge of the battery unit of the patron device over time.

FIG. 7C illustrates a plot 712 of variation in maximum available battery charge of the patron device 114A with variation in time, in accordance with an embodiment of the present disclosure. In the plot 712, the maximum available battery charge of the patron device 114A is plotted against a Y-axis 714 and corresponding time is plotted against an X-axis 716. The maximum available battery charge of a battery unit of the patron device 114A is plotted with respect to time for generating the curve 718 representing the variation in maximum available battery charge of the patron device 114A with variation in time. The curve 718 indicates that the maximum available battery charge degrades as time increases.

A maximum available battery charge value for a new battery unit of the patron device 114A is indicated by a maximum battery charge value 720. The curve 718 slopes in a downward direction indicating a decrease from the maximum battery charge value 720 of the battery unit in the patron device implying less available use of the patron device 114A before the patron device 114A discharges. The control server 110 may set a threshold value referred to as a minimum battery charge value 722 for a patron device. The minimum battery charge value 722 for the patron device 114A may be used as a reference that indicates that the maximum available charge available on device 114A has degraded to a point that the battery should be replaced. When a battery charge value of the patron device crosses below the minimum battery charge value 722 that is permissible for operating the patron device, the control server 110 may alert a vendor or a maintenance personnel. The vendor or maintenance personnel may remove the patron device 114A from service and replace the battery within the patron device 114A, thereby ensuring that the patron device 114A is serviced prior to a failure.

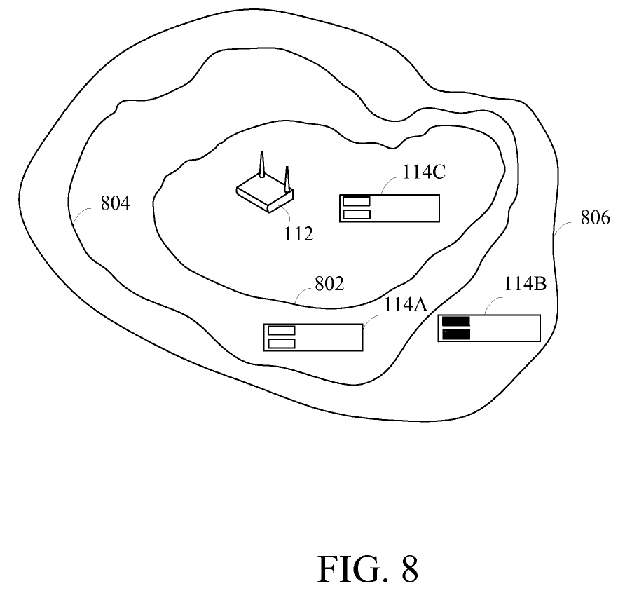

FIG. 8 illustrates variation in signal levels received by the plurality of patron devices 114 in communication with the wireless access point 112 with increasing distance from the wireless access point 112, in accordance with an embodiment of the present disclosure. As explained in conjunction with FIG. 1, the plurality of patron devices 114 communicate with the control server 110 using the communication network that includes the wireless access point 112. Wireless signals received by the control server 110 from the plurality of patron devices 114 are monitored for signal levels for detecting patron devices of the plurality of patron devices 114 that have drifted out of a coverage area of the wireless access point 112 for communication purposes. The control server 110 may monitor signal levels of signals received from a patron device of the plurality of patron devices 114 for a signal level threshold. Signal levels below the signal level threshold may provide indication to the control server 110 that the patron device transmitting the wireless signals may have drifted out of a coverage area from the wireless access point 112. The control server 110 may perform at least one of activating the vibration module in the patron device, delivering an audible message to the patron device, delivering a multimedia message to a display module, such as the display module 208 of the patron device, and flashing soft key lights in a sequence for the customer using the patron device.

In one embodiment of the present disclosure, the patron device 114A detects that the patron device 114A has drifted out of the coverage area for communication with the wireless access point 112 when a wireless signal received from the control server 110 or the master patron device, via the wireless access point 112 has a signal level less than the signal level threshold established by the control server 110. The patron device 114A may be configured to accordingly alert a customer using the patron device 114A that the device has drifted out of the coverage area. The master patron device may be similarly configured. It will be evident to a person skilled in the art that the customer may be alerted in a variety of ways including, but not limited, to activating the vibration module or by displaying a multimedia message. In another embodiment of the present disclosure, the control server 110 may activate a Global Positioning System (GPS) in a patron device when the control server 110 detects that the patron device 114A is drifting out of coverage area for communication with the wireless access point 112. The patron device 114A may also be configured to activate the GPS in the patron device 114A when its received signal level drops below a signal level threshold.

FIG. 8 depicts distances from the wireless access point 112 such as a perimeter range 802, a perimeter range 804 and a perimeter range 806 for receiving a signal level A of a wireless signal, a signal level B of a wireless signal and a signal level C of a wireless signal, respectively by the plurality of patron devices 114. Signal levels of the wireless signals received by the plurality of patron devices 114 from the control server 110 or the master control device progressively deteriorate with increase in distance from the wireless access point 112. In FIG. 8, the signal level B of a wireless signal received at the perimeter range 804 has a lower value than the signal level A of a wireless signal received at the perimeter range 802. Further, the signal level C of a wireless signal received at the perimeter range 806 has a lower value than the signal level B of a wireless signal received at the perimeter range 804.

Furthermore, in FIG. 8, the patron device 114C is depicted to be within the perimeter range 802 for receiving a wireless signal at the signal level A and is considered within range of the wireless access point 112. The patron device 114A is depicted outside the perimeter range 802 for receiving a wireless signal at the signal level A, but within the perimeter range 804 for receiving the wireless signal at the signal level B. The patron device 114A is considered within range of the wireless access point 112. The patron device 114D is depicted to be outside the perimeter range 804 for receiving a wireless signal at the signal level B, but within the perimeter range 806 for receiving the wireless signal at the signal level C. The patron device 114D is considered out of communication range of the wireless access point 112. Appropriate instructions may be activated on the patron device 114B, the master patron device, such as the patron device 114C, and the control server 110 (not shown) for managing communication with the patron device 114D. Further, a patron device outside the perimeter range 806 is also considered out of communication range of the wireless access point 112. In general, depending upon location of a patron device within the coverage area for communication with the wireless access point 112, instructions may be activated on the patron device, the master patron device and the control server 110 for managing communication with the patron device.

In one embodiment of the present disclosure, the GPS within a patron device may be used to locate patron devices of the plurality of patron devices 114 that are identified as being in the out of coverage area for communicating with the wireless access point 112. The control server 110 may be configured to activate the GPS in the patron devices for locating the patron devices when the patron devices begin to drift out of the coverage area of the wireless access point 112. In addition, or alternatively, the patron devices may be configured to activate GPS functionality in the patron devices when they detect a received signal level below a predetermined signal level threshold. For instance, patron devices may activate the GPS and initiate transmission on a defined frequency after a pre-defined time duration for loss of transmission has lapsed. A master patron device may be configured to listen to the transmission on the defined frequency and locate the patron devices.

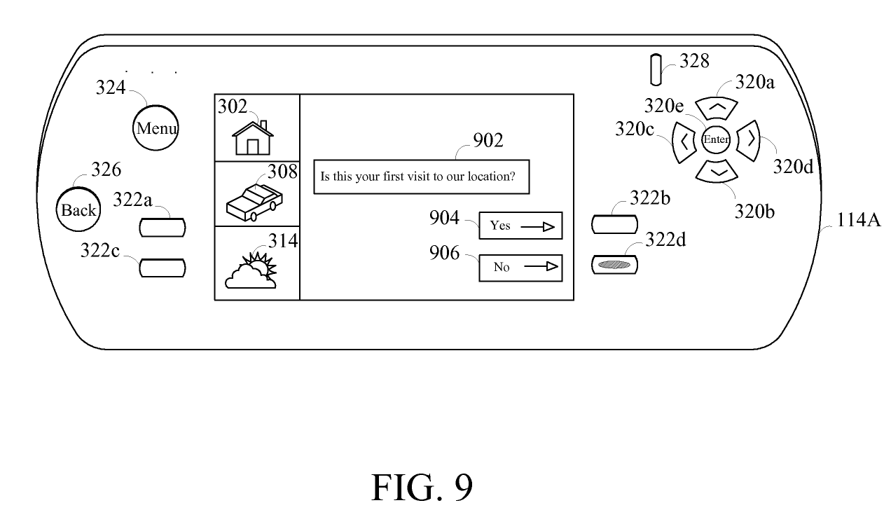

FIG. 9 illustrates a survey application display screen displayed on a display screen of the patron device 114A, in accordance with an exemplary embodiment of the present disclosure. The survey application display screen displays a text box 902 including an exemplary survey question ‘Is this your first visit to our location?’. In addition to the text box 902, the display screen displays a text box 904 and a text box 906 including text ‘Yes’ and ‘No’ respectively, as answer options to the exemplary survey question included in the text box 902. A customer may enter a customer response to the survey question in the text box 902 by using the navigation keys 320 or the soft keys 322, as explained in conjunction with FIG. 3A.

A vendor may customize the patron device 114A to display one or more questions, hereinafter collectively referred to as ‘survey questions’, when the patron device 114A is provided to a customer. The vendor may utilize a master patron device, such as the master patron device explained in conjunction with FIG. 5D for customizing the survey questions on the patron device 114A. The survey questions may be aimed at improving service or product offerings provided at the vendor location 102, decreasing waiting time for customers, fine-tuning multimedia content delivered to the customers, optimizing operations at the vendor location 102, and the like. Survey questions may also be displayed within advertisements displayed on the patron device for specific use by the advertiser and/or by an owner of the network other than the vendor. The patron device 114A may capture customer input for providing responses to the survey questions and deliver data representative of the customer responses to the control server 110 for further processing. It will be evident to those skilled in the art that the survey questions may be displayed on each patron device of the plurality of patron devices 114 when the each patron device is provided to a customer. Alternatively, the survey questions may be displayed at random time intervals on the plurality of patron devices 114.

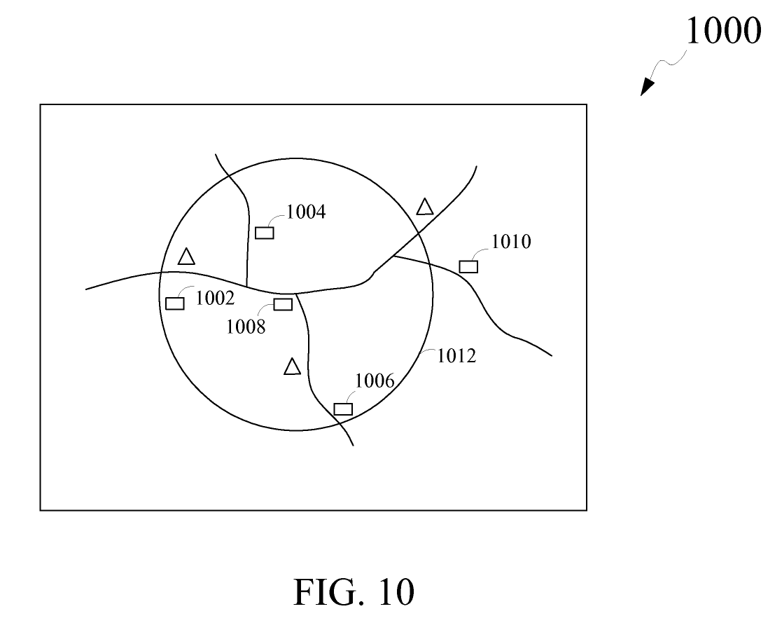

FIG. 10 illustrates vendor locations, such as the vendor location 102, in a geographical area 1000 that receive multimedia content from at least one multimedia content source, in accordance with an exemplary embodiment of the present disclosure. More specifically, the geographical area 1000 includes a vendor location 1002, a vendor location 1004, a vendor location 1006, a vendor location 1008 and a vendor location 1010. The vendor locations 1002, 1004, 1006, 1008 and 1010 may be one of a restaurant, a hair salon, an automotive repair establishment, a hospitality service establishment, and the like. The multimedia content may be provided to customers at targeted vendor locations, for example, the vendor locations 1002, 1004 and 1006, by utilizing patron devices, such as the plurality of patron devices 114 available at the targeted vendor locations. For example, an advertiser may wish to target vendor locations in a specific geographic region, such as the geographic area 1000, for providing advertising content. For example, a merchant who owns a flower shop represented by the vendor location 1008 may wish to deliver the multimedia content, such as an advertisement to potential customers within a radius 1012 of the flower shop, as shown in FIG. 10. Further, the advertiser may have an option of varying the radius 1012 to a desired distance to selectively target customers at the vendor locations.

Further, the advertiser may select the type of venues at which the multimedia content may be displayed. Restaurants, medical and automotive repair establishments, and the like, may be selected for providing the multimedia content. A demographic profile of the targeted vendor locations to display the multimedia content may be provided to inform the advertiser of customers who may view the multimedia content. The multimedia content may be selected for providing the multimedia content to one or more specific vendor locations. Further, the advertiser may have an option of selecting the vendor locations for providing the multimedia content based on demographic parameters, such as, age or gender of the customers who will view the multimedia content. The multimedia content may then be delivered to people matching the demographic parameters set by the advertiser. A demographic profile of the vendor locations may be obtained from information provided by vendors at the vendor locations, statistics derived from customer input obtained through the survey questions on patron devices, or public information. The age and gender of customers may be obtained using the patron device through survey questions displayed on the patron devices as explained in conjunction with FIG. 9.

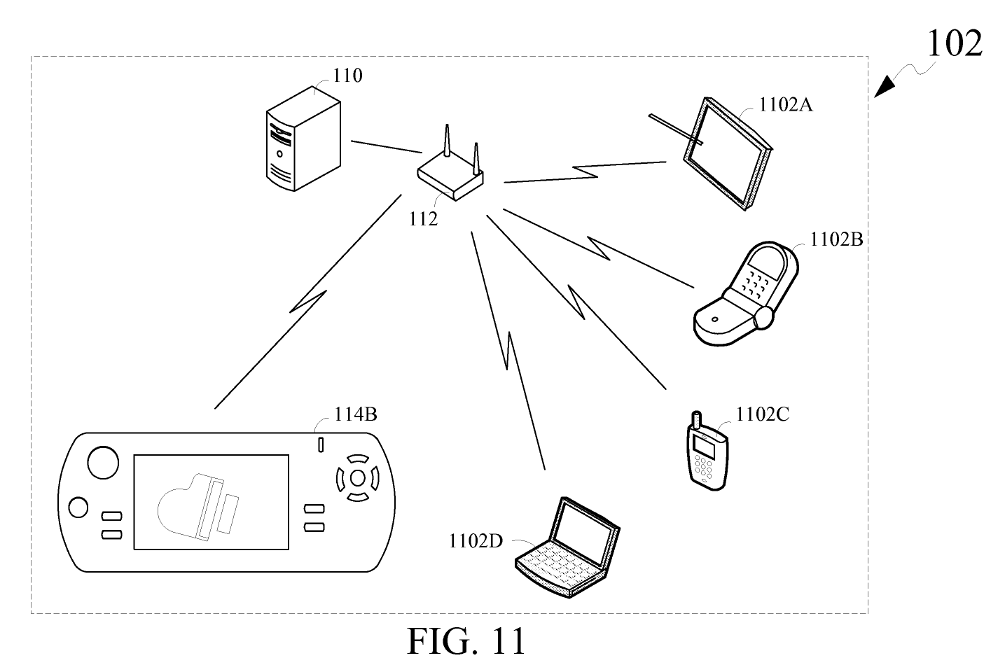

FIG. 11 illustrates integration of customer devices at the vendor location 102 into the system explained in conjunction with FIG. 1, for providing multimedia content to customers, in accordance with an exemplary embodiment of the present disclosure. FIG. 11 depicts the vendor location 102 configured with the control server 110, the plurality of patron devices 114 (not shown), the master patron device and the wireless access point 112. The customers at the vendor location 102 may also possess communication devices configured with a display screen such as a touch screen computing device 1102A, a cell phone 1102B, a walkie-talkie device 1102C and a laptop computer 1102D. The communication devices 1102A, 1102B, 1102C and 1102D will hereinafter be collectively referred to as customer devices 1102.

The customer devices 1102 may be integrated into the system for receiving the multimedia content from the control server 110 or the master patron device. The customer devices 1102 may request authorization for communicating with the control server 110. On receiving the authorization, the control server 110 may be configured to download the application configured for displaying multimedia content on the customer devices 1102. A navigation menu may appear on the customer devices 1102, in a similar manner as on the patron device 114A as explained in conjunction with FIG. 3A, while the functionality of at least one of the navigation keys 320 and/or the soft keys 322 on the patron device 114A may be mapped to specific keys on the customer devices 1102. It will be evident to those skilled in the art that only limited information may be provided to the customer devices 1102 based on the discretion of the control server 110 and the content source provider explained in conjunction with FIG. 1.

Providing multimedia content to customers at a vendor location may also be explained by the following method. The method comprises transmitting the multimedia content by a control server, such as the control server 110, to a patron device of a plurality of patron devices such as the plurality of patron devices 114 over a communication network. The patron device is provided to a customer at the vendor location. The patron device is configured to display the multimedia content provided by the control server for providing the multimedia content to the customer. The control server may further receive the multimedia content from at least one multimedia content source. Examples of at least one multimedia content source may include a remote portal server such as the remote portal server 106, a physical media such as a CD-ROM, a diskette or a hard disk drive, an internet website or data feeds such as an RSS feed.

The patron device further receives customer input from the customer using the patron device and provides multimedia content information based on the customer input to the control server. The control server may then provide the multimedia content to the patron device based on the multimedia content information. The control server may also activate a GPS in the patron device for locating the patron when the patron device drifts out of a coverage area for communicating with a wireless access point of the communication network for providing the multimedia content to the customer.

The system explained in conjunction with FIG. 1 and the method for providing multimedia content to customers at a vendor location may be especially advantageous for promotion of products and services. Customers waiting in premises of the vendor location or in waiting areas may be provided a patron device and the multimedia content may be provided to such customers. The multimedia content may be used for entertainment, advertisement, vendor location information, fulfilling special interest such as sports, games, weather, automotive inventory, real estate, movie schedules, community information, classifieds, charity and the like. Further, the multimedia content is provided in an interactive format and the customer inputs are further aggregated, formatted and analyzed to provide more targeted multimedia content to the customers. Providing such targeted multimedia content may boost sales of products and services. Further, customers in waiting areas waiting for products and services, or even customers being serviced such as customers seated in a restaurant, a lounge or under a hair dryer at a hair salon, may better utilize their time by interacting with the applications on the patron device. Furthermore, the system also facilitates integration with Point-of-Sale (POS) systems, thereby enabling the customers to make remote purchases of products and services.

According to one aspect of the present disclosure there is provided a system for providing multimedia content to customers at a vendor location. The system may include a control server, the control server capable of receiving the multimedia content from at least one multimedia content source; a plurality of mobile handheld patron devices; and at least one charging dock for supplying power for charging a battery within at least one of the plurality of patron devices. Each patron device of the plurality of patron devices may be configured to communicate with the control server over a communication network for receiving the multimedia content from the control server, and may be capable of displaying the multimedia content received from the control server for providing the multimedia content to a customer at the vendor location. One of the plurality of patron devices may be configured as a master patron device for managing the other ones of the plurality of patron devices.

According to another aspect of the present disclosure, there is provided a method for providing multimedia content to customers at a vendor location including: transmitting the multimedia content, e.g. from a control server, to a mobile handheld patron device of a plurality of patron devices, the patron device provided to a customer at the vendor location, wherein the multimedia content is transmitted by the control server to the patron device over a communication network; and displaying the multimedia content on the patron device for providing the multimedia content to the customer.

According to yet another aspect of the disclosure, there is provided a method for communicating multimedia content to customers at a vendor location, the method including: providing a plurality of mobile handheld patron devices capable of displaying the multimedia content to a customer at the vendor location, each of the patron devices including at least one vibration motor; and energizing at least one vibration motor of at least one of the patron devices to provide a time-varying vibration energy level.

According to another aspect of the disclosure, there is provided a method for displaying an advertisement for goods or services to customers at a vendor location, the method including: providing a plurality of mobile handheld patron devices capable of displaying the advertisement; defining an advertising target associated with the vendor location; and delivering the advertisement from an advertiser to the plurality of mobile handheld patron devices only within the advertising target.

According to a further aspect of the disclosure, there is provided a system for providing multimedia content to customers at a vendor location, the system including: a plurality of mobile handheld patron devices, each patron device of the plurality of patron devices being capable of displaying the multimedia content to a customer at the vendor location; at least one charging dock for receiving each of the plurality of patron devices and supplying power for charging a battery within each of the plurality of patron devices; and a plurality of status indicators, each of the status indicators including a light source associated with and powered by a different associated one of the plurality of patron devices, for indicating an availability status of the associated one of the plurality of patron devices.

According to another aspect of the disclosure, there is provided a system for providing multimedia content to customers at a vendor location, the system including: a control server, the control server capable of receiving the multimedia content from at least one multimedia content source; and a plurality of mobile handheld patron devices, each patron device of the plurality of patron devices being configured to communicate with the control server over a communication network for receiving the multimedia content from the control server, and being capable of displaying the multimedia content received from the control server for providing the multimedia content to a customer at the vendor location, at least one of the plurality of patron devices including an associated battery and being configured to monitor current draw from the battery and communicate data representative of the current draw to the control server, the control server being configured to receive the data representative of the current draw and provide notification that the battery has a charge below a predetermined threshold.

As described above, the embodiments of the present disclosure may be embodied in the form of computer-implemented processes and apparatuses for providing multimedia content to customers at a vendor location. Embodiments of the present disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the present disclosure. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A system for providing multimedia content to customers at a vendor location, the system comprising:
a plurality of mobile handheld patron devices, each patron device of the plurality of patron devices being capable of displaying the multimedia content to a customer at the vendor location;
at least one charging dock for receiving each of said plurality of patron devices and supplying power for charging a battery within each of said plurality of patron devices; and
a plurality of status indicators, each of said status indicators comprising a light source associated with and powered by a different associated one of said plurality of patron devices, for indicating an availability status of said associated one of said plurality of patron devices.

2. The system of claim 1, said system further comprising: a control server capable of receiving the multimedia content from at least one multimedia content source; wherein each of said plurality of patron devices is configured to communicate with the control server over a communication network for receiving the multimedia content from the control server, and wherein said control server is configured to control each of said status indicators to indicate said availability status of said associated ones of said plurality of patron devices.

3. The system of claim 1, wherein said availability status of each of said associated ones of said plurality of patron devices is determined in response to a status of communication between said control sever and said each of said associated ones of said plurality of patron devices.

4. The system of claim 1, said control server is configured to send a request to a remote server for a replacement one of said plurality of patron devices in response to said availability status.

5. The system of claim 1, wherein said status indicators are disposed on said associated ones of said plurality of patron devices.

6. The system of claim 1 wherein said status indicators are disposed on said charging dock.

7. A system for providing multimedia content to customers at a vendor location, the system comprising:
a control server, the control server capable of receiving the multimedia content from at least one multimedia content source; and
a plurality of mobile handheld patron devices,
each patron device of the plurality of patron devices being configured to communicate with the control server over a communication network for receiving the multimedia content from the control server, and being capable of displaying the multimedia content received from the control server for providing the multimedia content to a customer at the vendor location,
at least one of said plurality of patron devices comprising an associated battery and being configured to monitor current draw from said battery and communicate data representative of said current draw to said control server,
said control server being configured to receive said data representative of said current draw and provide notification that said battery has a charge below a predetermined threshold.
